(19) United States
(12) Patent Application Publication
(10) Pub. No.: US 2009/0165422 A1
(43) Pub. Date: Jul. 2, 2009

(54) Method of marking truss systems

(75) Inventors: Michael R. Strickland, Richmond Hill (CA); Douglas M. Fox, Kitchener (CA); Richard Wilson Strickland, Richmond Hill (CA)

Correspondence Address: Ralph A. Dowell of DOWELL & DOWELL P.C., 2111 Eisenhower Ave, Suite 406, Alexandria, VA, 22314, US

(73) Assignee: PARADIGM FOCUS PRODUCT DEVELOPMENT INC., Richmond Hill (CA)

(21) Appl. No.: 12/292,341

(22) Filed: Nov. 17, 2008

Related U.S. Application Data
(63) Continuation-in-part of application No. PCT/CA2007/000870, filed on May 17, 2007.
Application No. PCT/CA2007/000870 is a continuation-in-part of application No. 60/996,424, filed on Nov. 16, 2007.
(60) Provisional application No. 60/801,054, filed on May 18, 2006.

(51) Int. Cl. E04B 1/00; B42D 15/00

(52) U.S. Cl. 52/741.1; 283/70

(57) ABSTRACT

There is provided a method of marking truss systems including the steps of: inputting project/customer data at point of sale into a mass-customized truss system design engine; generating manufacture information by the design engine; providing a plurality of truss members; and marking each of the plurality of truss members with the manufacturing information. In another aspect of the invention there is provided a method of marking truss systems comprising the steps of: determining a plurality of roll formed members for a particular truss system having a plurality of in-plane trusses and out-of-plane members connected to the in-plane trusses; and roll forming, cutting and marking at least a portion of the plurality of roll formed members providing detailed and complete information for: assembling the in-plane trusses; erecting the in-plane trusses; and installing the out-of-plane members.

### CROSS REFERENCE TO RELATED PATENT APPLICATION

This patent application relates to U.S. Provisional Patent Application Ser. No. 60/996,424 filed on Nov. 16, 2007 entitled METHOD OF MAKING TRUSS SYSTEMS, all of which is incorporated herein by reference in its entirety.

### FIELD OF THE INVENTION

This invention relates to steel trusses and in particular a method of marking steel trusses systems.

### BACKGROUND OF THE INVENTION

The manufacture, marking, assembly and erection of light steel framing trusses is generally labour intensive. Typically the members used in the light steel framing trusses are manufactured in standard lengths. The standard lengths are then cut to fit the particular truss that is being erected. Accordingly, there is often a lot of waste when the members are cut to fit.

The traditional method of marking a truss is a multi-step process. Firstly the members are roll formed and then using the project drawings the members are marked. Thereafter the in-plane trusses are assembled and erected. The out-of-plane connectors and members are laid out and marked and then the out of plane members are erected.

Therefore it would be advantageous to provide a method of marking trusses that minimizes waste, reduces the labour and is relatively easy to follow.

### SUMMARY OF THE INVENTION

The present invention relates to a method of marking a truss system. The method includes the steps of:

determining a plurality of roll formed members for a particular truss system having a plurality of in-plane trusses and out of plane truss portions connected to the in-plane trusses;

roll forming and marking at least a portion of the plurality of roll formed members providing detailed and complete information for:

assembling the in-plane trusses;

erecting the in-plane trusses; and

installing the out-of-plane members.

The out-of-plane members may include bridging member, trusses and a combination thereof.

In another aspect of the invention there is provided a method of marking truss systems including the steps of:

inputting project/customer data at point of sale into a mass-customized truss system design engine;

generating manufacture information by the design engine;

providing a plurality of truss members; and

marking each of the plurality of truss members with the manufacturing information.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is a perspective view of a truss system constructed in accordance with the present invention;

FIG. 2 is an enlarged perspective view of detail 2 on FIG. 1 of the truss system of the present invention and showing bridging connecting out-of-plane to chords of out-of-plane trusses;

FIG. 3 is an enlarged perspective view of detail 3 on FIG. 1 of the truss system of the present invention and showing chord members connecting out-of-plane to adjacent chords of primary in-plane trusses at the ridge;

FIG. 4 is an enlarged perspective view of detail 4 on FIG. 1 of the truss system of the present invention and showing connecting out-of-plane members to chords of primary in-plane trusses;

FIG. 5 is a perspective view of a primary in-plane truss of the truss system of the present invention;

FIG. 6 is an enlarged perspective view of detail 6 on FIG. 5 and showing a centre span joint on the bottom chord;

FIG. 7 is an enlarged perspective view of detail 7 on FIG. 5 and showing a top chord joint;

FIG. 8 is an enlarged perspective view of detail 8 on FIG. 5 and showing a bottom chord joint;

FIG. 9 is an enlarged perspective view of detail 9 on FIG. 5 and showing a end joint;

FIG. 10 is an enlarged perspective view of marking information at the joints;

FIG. 11 is an enlarge perspective view of a joint of a plurality of web members connected to a chord member;

FIG. 12 is an enlarged perspective view of the joint of FIG. 11 and further including a sloped out-of-plane member connected thereto.

FIG. 13 is a sample of the marking that would be at the joint of FIGS. 11 and 12;

FIG. 14 is an enlarged perspective view of an alternate joint of a plurality of web members connected to a chord member;

FIG. 15 is an enlarged perspective view of the joint of FIG. 14 and further including a bridging member connected thereto;

FIG. 16 is a sample of the marking that would be at the joint of FIGS. 14 and 15;

FIG. 17 is an enlarged perspective view of an alternate joint of a top chord, a bottom chord and a main support member;

FIG. 18 is an enlarged perspective view of the joint of FIG. 17 and further including a hold-down connector attached thereto;

FIG. 19 is a sample of the marking that would be at the joint of FIGS. 17 and 18;

FIG. 20 is an enlarged perspective view of an alternate joint of a pair of chord members;

FIG. 21 is an enlarged perspective view of the joint of FIG. 20 and further including a connector attaching the chord members together;

FIG. 22 is a sample of the marking that would be at the joint of FIGS. 20 and 21;

FIG. 23 is a perspective view of an in-plane truss with out-of-plane members attached thereto;

FIGS. 24 (a), (b), (c), (d) and (e) are cross sectional views of different truss types that may use the truss chord member and truss web member of the present invention;

FIG. 25 is a flow chart showing the steps in the method of marking a truss system in accordance with the present invention; and

FIG. 26 is a flow chart of a mass customization system for use with the truss assembly marking system of the present invention.

### DETAILED DESCRIPTION OF THE INVENTION

Referring to FIGS. 1 to 4 the truss system of the present invention is shown generally at 10. The truss system 10 includes a plurality of primary in-plane trusses and out-of-plane portions. The truss system of the present invention may include a wide variety of different types of primary in-plane trusses and out-of-plane portions.

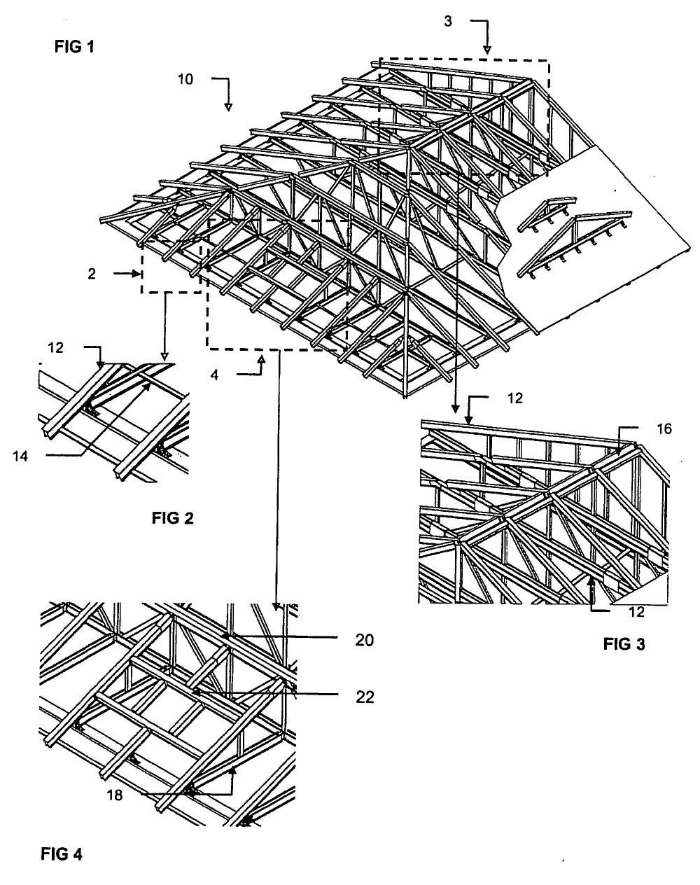

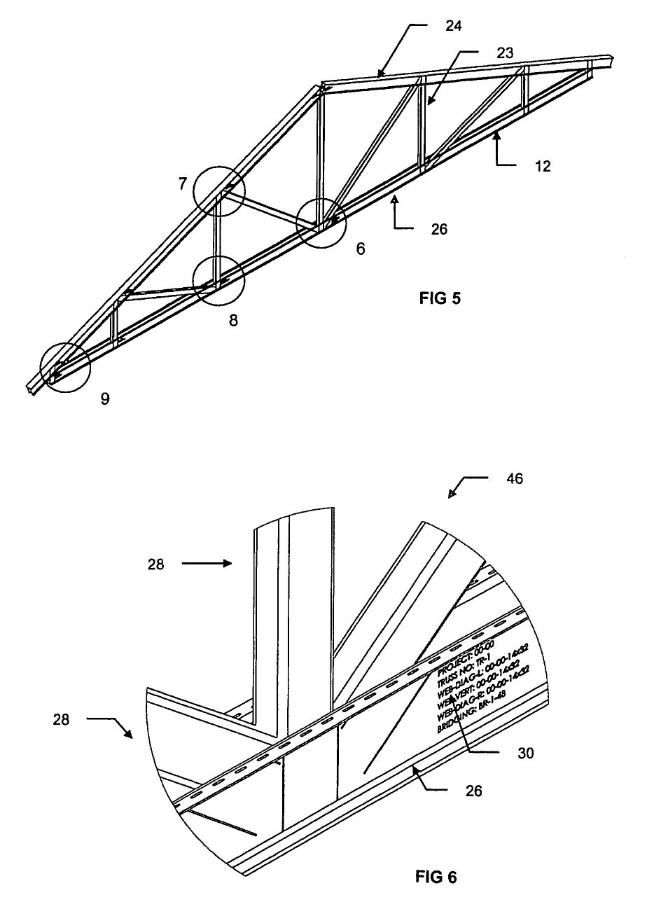

For example as shown in FIG. 2 the primary in-plane trusses 12 are connected with an out-of-plane bridging member 14. Another example is shown in FIG. 3 wherein a plurality of adjacent primary in-plane trusses 12 are connected along the ridge with out-of-plane chord members 16. A further example is shown in FIG. 4 wherein in-plane jack trusses 18 are connected out-of-plane to a hip girder truss 20. Out-of-plane chords 22 connect jack trusses 18. This type of truss arrangement may be used to frame an opening for a sky light or the like.

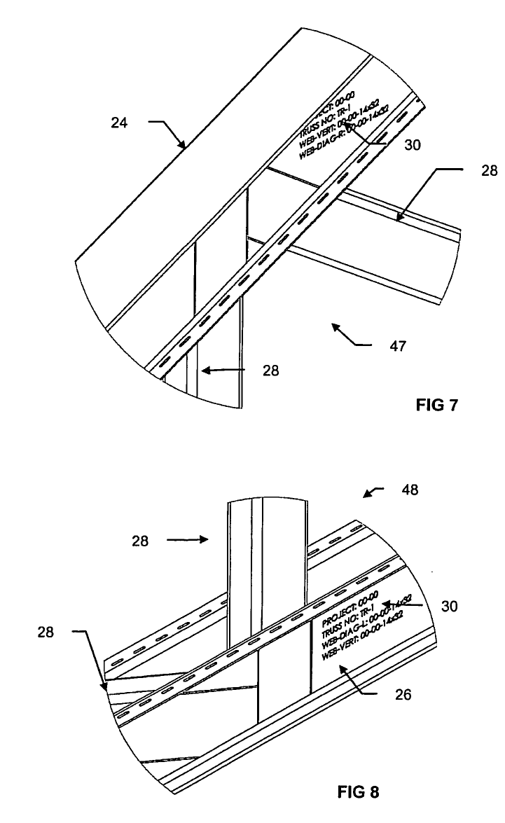

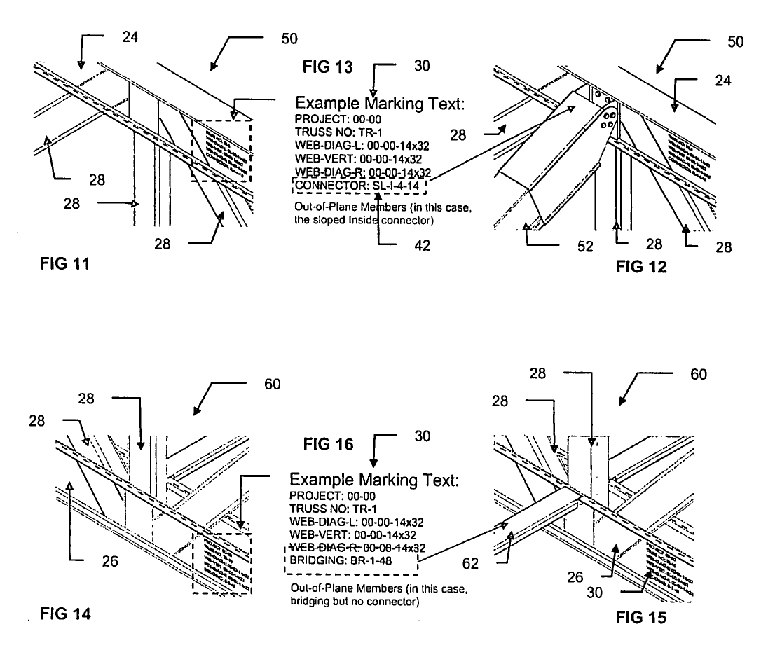

An example of a double Howe in-plane truss 12 is shown in FIG. 5. The in-plane truss includes a pair of top chords 24, a bottom chord 26 and a plurality of web members 23. Each joint has markings on the members to assist in the assembly and erection of the truss system. Examples of the joints of the truss shown in FIG. 2 are shown in FIGS. 6 to 9 and a sample of the marking is shown in FIG. 10. FIGS. 11 to 22 show examples of joints that include out-of-plane connections and sample connectors, as well as the samples of the markings that would be used at the joint.

Referring to FIG. 10 preferably the information included in the marking 30 is as follows: TRUSS PROJECT 32; PART NUMBER 33; L-DIAGL 34; WEB 36; R-DIAGR 38; BRIDGING 40; CONNECTOR 42 (as shown in FIG. 13). Item 32 provides the project identification number, 33 is the part number, 34 is the diagonal member to the left on the side of the node or joint, 36 is the web vertical member (the member perpendicular to the chord) and 38 is the diagonal member to the right of the vertical web member; the latter 33, 34, 36 and 38 are markings for in-plane members. Item 40 is the bridging member to be installed at the node or joint and item 42 provides information for a connector to be installed at the node. The latter two items 40, 42 are for the provision of out-of-plane members. Where a particular member is not to be installed at a particular node or joint, the text of that member is preferably omitted from the marking at the node. Alternatively, the information may be left blank at that item.

These markings provide specific information so that it is not necessary for the workers to handle drawings and or sketches normally required for the assembly of trusses. The detailed information provided for in plane and out of plane members reduces the chances of incorrect assembly of the members being attached to the chord members that are required to make a truss. This information allows for easy inspection by the design engineer and the quality control inspector, thereby providing completed trusses of the highest quality. It is obvious that a further embodiment can be the provision of type and quantity of fasteners.

In addition to the joint information there are also guide lines 44 marking the orientation of the members being connected and the specific location of these connections.

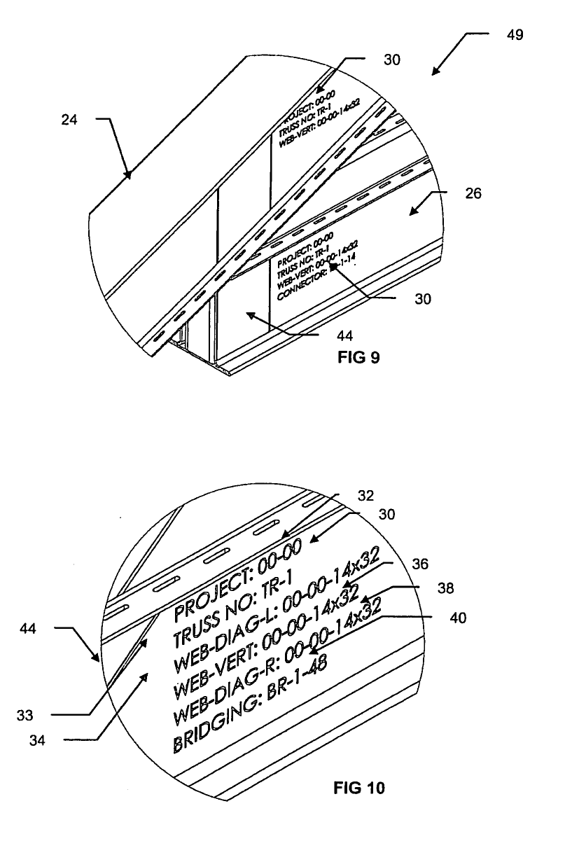

Specifically FIG. 6 shows a centre span joint 46 with a bottom chord 26, a right diagonal web member 28; a left diagonal web member 28 and a vertical web member 28. FIG. 7 shows a top chord joint 47 with a top chord 24, a vertical web member 28 and a right diagonal web member 28. FIG. 8 shows a bottom chord joint 48 with a bottom chord 26, a vertical web member 28 and a left diagonal web member 28. FIG. 9 shows an end joint 49 with a top chord 24 and a bottom chord 26. A vertical web member (not visible) joins the chords together. At each joint markings 30 include information on the members that are to be connected together at a joint.

FIGS. 11, 12 and 13 show a joint 50 in an in-plane truss having a top chord 24 with a vertical web member 28, a right diagonal web member 28 and a left diagonal web member 28 connected thereto. An out-of-plane member 52 is connected to the top chord 24 using a sloped inside connector 54 as shown in FIG. 12. FIG. 13 shows the marking 30 for joint 50.

FIGS. 14, 15 and 16 show a joint 60 in an in-plane truss having a bottom chord 26, a vertical web member 28, a right diagonal web member 28 and a left diagonal web member 28 connected thereto. Out-of-plane bridging members 62 are attached to joint 60 as shown in FIG. 15 and the marking 30 for joint 60 is shown in FIG. 16.

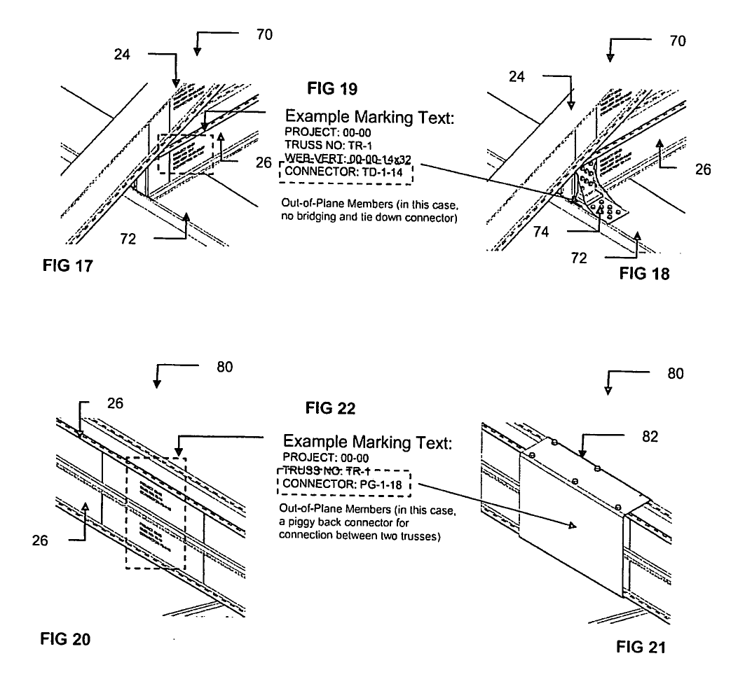

FIGS. 17, 18 and 19 show an end joint 70 similar to that shown in FIG. 9 and out-of-plane bridging member 72 attached thereto. The end joint 70 includes a top chord 24, a bottom chord 26 and a vertical web member (not visible). A tie down connector 74 connects the bridging member 72 to end joint 70.

FIGS. 20, 21 and 22 shows a joint 80 of a pair of bottom chord members 26 connected together with a piggy back connector 82. The marking 30 for joint 80 is shown in FIG. 22.

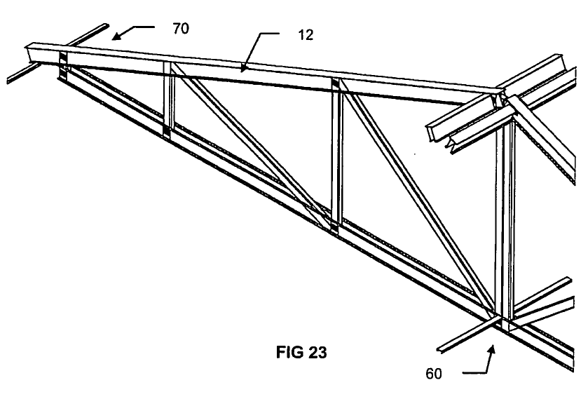

FIG. 23 shows a primary in-plane truss 12 and showing an example of a joint 70 and a joint 60.

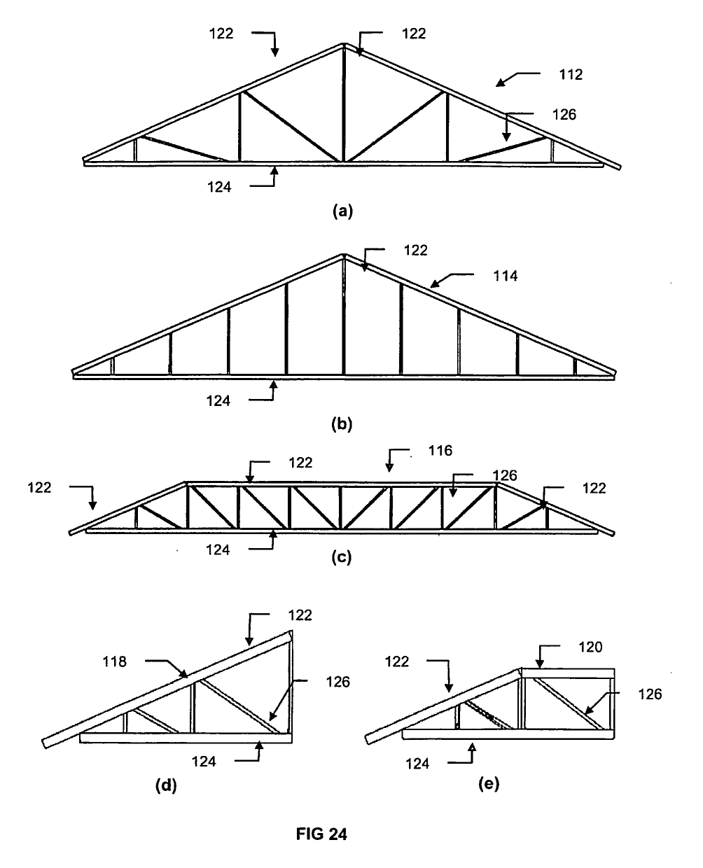

The truss chords and truss webs described above may be used in a number of different types of trusses. Some examples of the types of trusses in which they may be used are shown in FIG. 24 wherein (a) is a double Howe truss 112, (b) a gable truss 114, (c) a hip truss 116, (d) a mono truss 118 and (e) a mono-hip truss 120. In turn these trusses may be used in a truss system, an example of which is shown in FIG. 1. These trusses each include at least one top truss chord 122, a bottom truss chord 124 and a plurality of truss webs 126.

As shown above each joint has makings on at least one of the members being connected. Typically the markings will be found on the top chord or the bottom chord. The markings include lines which aid in the assembly of the truss system. In addition to the markings being provided on the chord members to assist with assembly and follow up inspection, all the supplementary members can be marked to include identification marks.

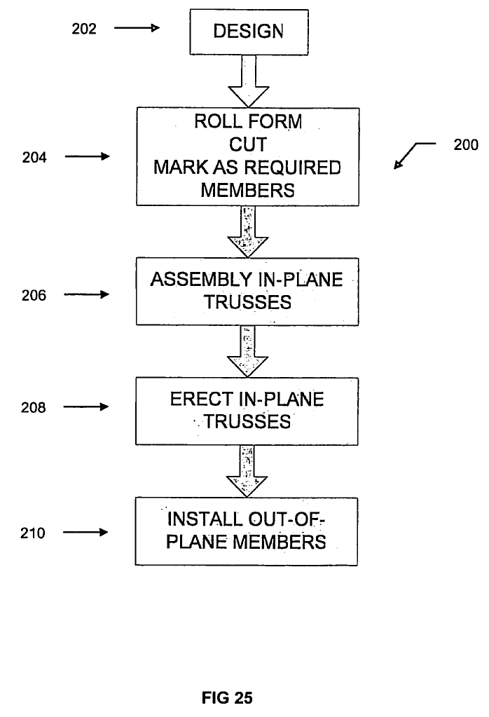

The method of marking the trusses of the present invention is shown by way of a flow chart 200 in FIG. 25. The method 200 includes the steps of determining the members required 202; roll forming, cutting and marking the members 204; assembling the primary in-plane trusses 206; erecting the in-plane trusses 208 and installing the out-of-plane truss portions. It will be appreciated by those skilled in the art that the installing the out-of-plane truss portions may be done before the truss system is erected. The order of these last two steps will depend on the complexity of the truss system, the available hoisting equipment and lifting capacity and the preferences of the workers.

In order to facilitate truss system assembly each truss member has project information 30 stamped onto the member as described above. This invention provides a truss system wherein the chords can be marked at each connection node during manufacture by means of ink or etching marks that indicate member locations, member types, supplementary connectors and fastener requirements. The mass-customized structural chord members have a flat web portion that facilitates marking and provides a flat surface for simple connector and fastener installation. This invention provides a paradigm shift in the metal truss market given all the specific assembly information is provided on the manufactured parts; this reduces the need to carry and handle drawings on site and provides a better means for joint completion verification and inspection.

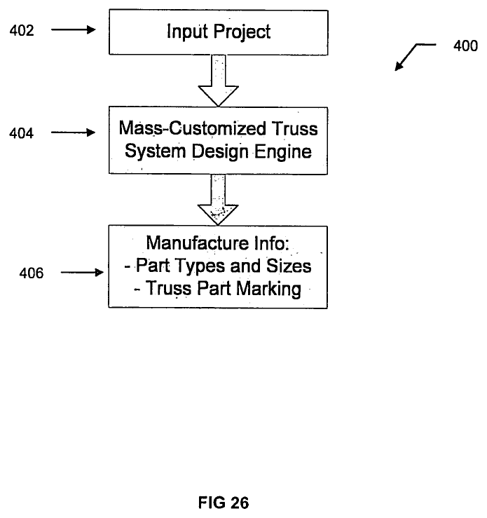

Embodiments of the trusses of this invention enable the delivery of highly customized parts using automated techniques that are possible by virtue of the fact that the system architecture has been developed using mass-customization techniques. This invention allows for delivery of customized trusses and related procurement services at high volumes at low costs. The mass-customized truss system is shown generally at 400 in FIG. 26. The system 400 provides for marking of truss systems including the sales, manufacture, assembly and project management for the delivery of truss systems from the Point of Sale and/or the Point of Design. Project/customer data is input at point of sale 402 to the mass-customized truss system design engine 404. The design engine determines manufacture information 406 including part types, size and truss part marking.

Standard Light Steel Framing (LSF) truss systems today do not accommodate out-of-plane connections and members in a simple and economical manner. An efficient truss system performs best when the longitudinal axis of members intersect at a common node point or joint, reducing eccentricity in the connectors and main members. Prior art does not easily accommodate out-of-plane connections for LSF trusses. To date nobody has customized a LSF truss system that easily and economically accommodates framing of LSF trusses out-of-plane.

Without standardized truss system architecture to accommodate out-of-plane conditions the job of building and installing trusses is very difficult. A system of standard connectors intended for out-of-plane conditions must be simple to use and to understand for the assembler, otherwise complex geometry is difficult to layout and build.

As evidenced by our invention considerable detail has been given to the provision of out-of-plane members and related connectors. Our product architecture results from determining the needs of the complete chain of truss supply and installation: roll forming, truss assembly and the truss erection. In our new truss technology connectors have been developed to deal with both standard and complex out-of-plane conditions that may be required in a LSF truss system. While a system with standard connections intended for complex conditions could be overly complex for the trades people to install, of particular relevance with this invention is that the method of truss marking inherently simplifies the assembly of out-of-plane connectors and members. The main truss chord connection nodes are marked to include relevant information and location for installing out-of-plane connectors and members. A marking to accommodate out-of-plane members would include all information required by the tradesperson at any phase of the work, this would include connector information with location and orientation, member information with location and orientation, and the number of fasteners required at each location. This out-of-plane information combined with the modular product architecture reduces the cost of assembly and inherently increases the quality of the installation; this invention provides a LSF Truss system that is Mass Customized to deal with out-of-plane members. Without the required detailed information being provided on the chord members for out-of-plane connectors and members the assembly of truss systems would otherwise be very complex and costly for the various trades involved.

Generally speaking, the systems described herein are directed to truss systems. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to truss systems and portions thereof.

As used herein, the terms “comprises” and “comprising” are to be construed as being inclusive and opened rather than exclusive. Specifically, when used in this specification including the claims, the terms “comprises” and “comprising” and variations thereof mean that the specified features, steps or components are included. The terms are not to be interpreted to exclude the presence of other features, steps or components.

What is claimed as the invention is:

1. A method of marking truss systems comprising the steps of:
determining a plurality of roll formed members for a particular truss system having a plurality of in-plane trusses and out-of-plane members connected to the in-plane trusses; and
roll forming, cutting and marking at least a portion of the plurality of roll formed members providing detailed and complete information for;
assembling the in-plane trusses;
erecting the in-plane trusses; and
installing the out-of-plane members.

2. A method of marking truss systems as claimed in claim 1 wherein the plurality of roll formed members include a plurality of bottom chords, a plurality of top chords and a plurality of web members.

3. A method of marking truss systems as claimed in claim 2 wherein the out-of-plane members include one of bridging members, trusses and a combination thereof.

4. A method of marking truss systems as claimed in claim 3 wherein the bottom chords and the top chords have the markings thereon.

5. A method of marking truss systems as claimed in claim 4 wherein the markings include guide lines showing the orientation of the members and information regarding the members meeting at a joint.

6. A method of marking truss systems as claimed in claim 5 wherein the markings further include information regarding connectors and bridging members where required.

7. A method of marking truss systems as claimed in claim 6 wherein the markings are made by way of one of ink and etching.

8. A method of marking truss systems as claimed in claim 5 wherein the markings include information chosen from the group consisting of project number, diagonal web left, diagonal web right, vertical web, bridging, connector and a combination thereof.

9. A method of marking truss systems including the steps of:
inputting project/customer data at point of sale into a mass-customized truss system design engine;
generating manufacture information by the design engine;
providing a plurality of truss members; and
marking each of the plurality of truss members with the manufacturing information.

10. A method of marking truss systems as claimed in claim 9 wherein the manufacture information includes part types, size and truss part marking.

11. A method of marking truss systems as claimed in claim 10 wherein the manufacture information adjacent to a node on each of the plurality of truss members.
